(19) United States
(12) Patent Application Publication
(10) Pub. No.: US 2014/0022053 A1
(43) Pub. Date: Jan. 23, 2014

(54) LOCK DEVICE

(71) Applicant: KABUSHIKI KAISHA TOKAI RIKA DENKI SEISAKUSHO, Aichi (JP)

(72) Inventors: Tomohiro Inoue, Aichi (JP); Kazuhito Yaragami, Aichi (JP); Masahiro Koyama, Aichi (JP)

(73) Assignee: KABUSHIKI KAISHA TOKAI RIKA DENKI SEISAKUSHO, Aichi (JP)

(21) Appl. No.: 13/939,432

(22) Filed: Jul. 11, 2013

(30) Foreign Application Priority Data
Jul. 18, 2012 (JP) 2012-159726

(51) Int. Cl. G07C 9/00

(52) U.S. Cl. CPC G07C 9/00174
USPC 340/5.61

(57) ABSTRACT

In transponder communication (near field wireless communication), an electronic key uses drive radio waves as a power source and thereby does not need to be supplied with power from a key battery. To establish transponder communication, the distance between the electronic key and the vehicle has to be shorter than that for smart communication. However, transponder communication can be performed to switch a plug lock device between a lock state and an unlock state when a smart system cannot perform smart communication that switches the lock device between different states.

### CROSS-REFERENCE TO RELATED APPLICATIONS

This application is based upon and claims the benefit of priority from prior Japanese Patent Application No. 2012-159726, filed on Jul. 18, 2012, the entire contents of which are incorporated herein by reference.

### BACKGROUND OF THE INVENTION

The present invention relates to a lock device that restricts connection and disconnection of a power plug to and from an inlet.

Electric vehicles run on battery power and are environmentally friendly. An electric vehicle includes an inlet that is connectable to a power plug extending from, for example, a household commercial power supply. The power plug is connected to the inlet to supply the vehicle with power from the commercial power supply. This allows for charging of the vehicle battery.

When charging the battery in such a manner, the power plug may be removed without authorization or be stolen. To prevent such a situation, a plug lock device is used to lock the power plug to the inlet and restrict unauthorized disconnection of the power plug.

Japanese Laid-Open Patent Publication No. 2011-244590 discloses a plug lock device switched between a lock state and an unlock state when a trigger switch, located proximal to an inlet, is operated by a user under the condition that wireless communication is established between the plug lock device and an electronic key held by the user (smart communication). This prevents a person who does not have the electronic key from disconnecting the power plug in an unauthorized manner and thereby improves security.

Japanese Patent No. 4379823 discloses a plug lock device switched between a lock state and an unlock state in accordance with the locking and unlocking of the vehicle doors.

Further, Japanese Laid-Open Patent Publication No. 2010-203074 discloses a wireless key system that allows for locking and unlocking of the vehicle doors by operating locking and unlocking switches on an electronic key.

In the plug lock device of Japanese Laid-Open Patent Publication No. 2011-244590, smart communication may not be established depending on the battery level of the electronic key or the radio wave environment. When smart communication cannot be established, the plug lock device cannot be switched between the lock state and the unlock state.

### SUMMARY OF THE INVENTION

One aspect of the present invention is a lock device for a power plug connected to and disconnected from an inlet arranged in a vehicle. The vehicle includes a near field wireless communication system that permits control of the vehicle upon determination that near field wireless communication has been established when transmitting drive radio waves and receiving a response signal from an electronic key that uses the radio waves as a power source. The lock device operates in a connection-disconnection restriction state, which restricts connection and disconnection of the power plug to and from the inlet, and a connection-disconnection permissible state, which permits connection and disconnection of the power plug to and from the inlet. The lock device includes a control unit configured to control and switch the lock device between the connection-disconnection restriction state and the connection-disconnection permissible state. The control unit is configured to permit switching of the lock device between the connection-disconnection restriction state and the connection-disconnection permissible state after the determination that near field wireless communication has been established by the near field wireless communication system.

A further aspect of the present invention is a controller arranged in a vehicle including an inlet and a lock device for a power plug connected to and disconnected from the inlet. The controller includes a first control unit that permits control of the vehicle upon determination that near field wireless communication has been established when transmitting drive radio waves and receiving a response signal from an electronic key that uses the radio waves as a power source. A second control unit controls the lock device to selectively restrict connection and disconnection of the power plug to and from the inlet. The second control unit is configured to permit operation of the lock device when the first control unit determines that the near field wireless communication has been established.

Another aspect of the present invention is a vehicle including an inlet for a power plug and a lock device arranged in the inlet. The lock device restricts connection and disconnection of the power plug to and from the inlet. A controller controls the vehicle. The controller includes a first control unit that permits control of the vehicle upon determination that near field wireless communication has been established when transmitting drive radio waves and receiving a response signal from an electronic key that uses the radio waves as a power source. A second control unit controls the lock device to selectively restrict connection and disconnection of the power plug to and from the inlet. The second control unit is configured to permit operation of the lock device when the first control unit determines that near field wireless communication has been established.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram showing the structure of a vehicle and an electronic key in a first embodiment;

FIG. 2 is a plan view showing areas to which request signals are transmitted from the vehicle in the first embodiment;

FIG. 3 is a flowchart showing the processing procedures of a vehicle controller in the first embodiment;

FIG. 4A is a flowchart showing the processing procedures of a vehicle controller in a second embodiment; and

FIG. 4B is a flowchart showing the processing procedures of a vehicle controller in a third embodiment.

### DETAILED DESCRIPTION OF THE INVENTION

### First Embodiment

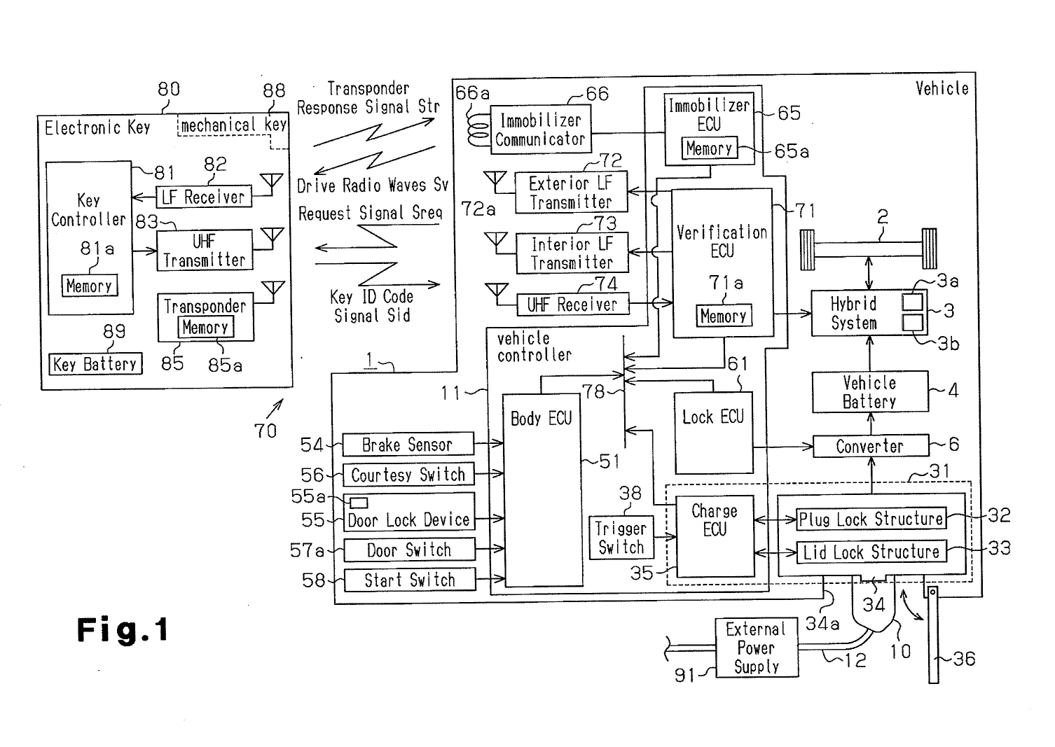

A hybrid vehicle 1 according to a first embodiment of the present invention will now be described with reference to FIGS. 1 to 3.

Referring to FIG. 1, the vehicle 1 performs wireless communication with an electronic key 80 to lock and unlock vehicle doors and switch between states permitting and restricting driving of the vehicle 1. The wireless communication also allows for a plug lock device 31 of the vehicle 1 to be switched between a lock state and an unlock state.

In the present example, an electronic key system is installed in the vehicle 1. The electronic key system includes a smart system and a transponder communication system (near field wireless communication system). The smart system automatically performs bidirectional wireless communication between the vehicle 1 and the electronic key 80 to permit locking and unlocking of the vehicle doors. The transponder communication system is used when the battery of the electronic key 80 drains to zero.

The structure of the electronic key 80 and the vehicle 1 will now be described.

Electronic Key

The electronic key 80 includes a key controller 81, an LF receiver 82, a UHF transmitter 83, a mechanical key 88, a transponder 85, and a key battery 89. The key battery 89 supplies the key controller 81, the LF receiver 82, and the UHF transmitter 83 with power but not the transponder 85.

The key controller 81 includes a non-volatile memory 81a that stores a unique key ID code. The vehicle 1 transmits a request signal Sreq on a low frequency (LF) band. When the key controller 81 receives the request signal Sreq from the vehicle 1 with the LF receiver 82, the key controller 81 transmits a key ID code signal Sid on an ultrahigh frequency (UHF) band to the vehicle 1.

The transponder 85 includes a non-volatile memory 85a. The memory 85a stores a unique transponder ID code.

When drive radio waves Sv are received from the vehicle 1, the transponder 85 transmits a transponder response signal Str that includes the transponder ID code. The transponder 85 operates on power induced by the received drive radio waves Sv and does not use the power of the key battery 89.

The electronic key 80 has a body that accommodates the removable mechanical key 88, which is used under emergency situations. The mechanical key 88 is used when the battery of the electronic key 80 drains to zero. The user fits the mechanical key 88 into a key cylinder 55a arranged on the outer side of a vehicle door and turns the mechanical key 88 to lock or unlock the vehicle door in cooperation with the key cylinder 55a.

Vehicle

As shown in FIG. 1, a vehicle controller 11 is installed in the vehicle 1. The vehicle controller 11 includes a verification electronic control unit (ECU) 71, a charge ECU 61, a body ECU 51, a lock ECU 35, and an immobilizer ECU 65. The ECUs 35, 51, 61, 65, and 71 are communicable with one another through an in-vehicle local area network (LAN) 78.

The vehicle 1 includes a hybrid system 3, a vehicle battery 4, and a plug lock device 31. The hybrid system 3 uses power generated by an engine 3a and a motor 3b to drive wheels 2. The vehicle battery 4 stores power that is supplied to the motor 3b. The plug lock device 31 is operated to switch between a lock state, which restricts connection and disconnection of the power plug 10 to and from the inlet 34, and an unlock state, which permits connection and disconnection of the power plug 10 to and from the inlet 34.

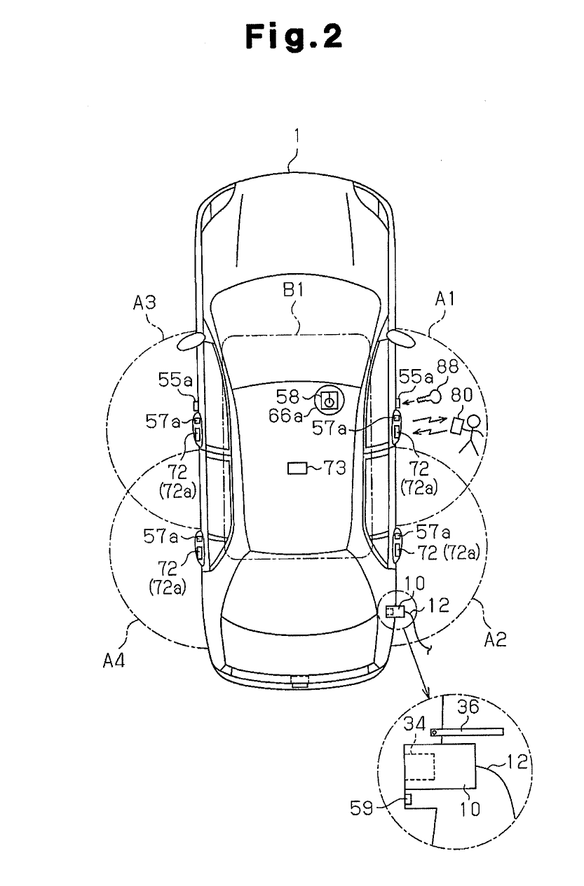

Referring to FIG. 2, a recessed power port 34a is formed in a side surface of the vehicle (specifically, behind rear right vehicle door). The vehicle 1 includes an inlet 34 and a charge lid 36. The inlet 34 is arranged in the power port 34a and functions as a socket for the power plug 10. The charge lid 36 is coupled to the side surface of the vehicle 1 and is movable between a position closing the power port 34a (close position) and a position opening the power port 34a (open position). When the charge lid 36 is located at the close position, the charge lid 36 conceals the inlet 34. The plug lock device 31 includes a plug lock structure 32 and a lid lock structure 33. The lid lock structure 33 holds the charge lid 36 at the close position. For example, when a lever (not shown) arranged near the drive seat is operated, the lid lock structure 33 moves the charge lid 36 to the open position. When the charge lid 36 is located at the open position, the inlet 34 is exposed to the exterior thereby allowing for the power plug 10 to be connected to the inlet 34. Connection of the power plug 10 to the inlet 34 connects the power plug 10 via the inlet 34 and a converter 6 to the vehicle battery 4. Further, the power plug 10 is supplied with power from an external power supply 91 via a charge cable 12. Accordingly, when the power plug 10 is connected to the inlet 34, AC power from the external power supply 91 may be supplied via the power plug 10 and the inlet 34 to the converter 6. The converter 6 converts the AC power from the power plug 10 to DC power and supplies the DC power to the vehicle battery 4. The charge ECU 61 controls the converter 6 to control the charging of the vehicle battery 4.

As shown in FIG. 1, the body ECU 51 is connected to a door lock device 55, door switches 57a, a start switch 58, courtesy switches 56, and a brake sensor 54.

As shown in FIG. 2, the four door switches 57a are respectively arranged in the outer door handles of four vehicle doors. When pushed, each door switch 57a provides the body ECU 51 with an operation signal indicating that the door switch 57a has been pushed.

Referring to FIG. 1, the start switch 58 is arranged in the passenger compartment proximal to the driver seat. When pushed, the start switch 58 provides the body ECU 51 with an operation signal indicating that the start switch 58 has been pushed. Each courtesy switch 56 detects the opening and closing of the corresponding vehicle door and provides the body ECU 51 with the detection result. The brake sensor 54 detects depression of the foot brake and provides the body ECU 51 with the detection result.

The verification ECU 71 includes a memory 71a that stores the key ID code of the registered electronic key 80. The verification ECU 71 is connected to exterior LF transmitters 72, an interior LF transmitter 73, and a UHF receiver 74.

As shown in FIG. 2, the vehicle 1 includes the four outer door handles and the four exterior LF transmitters 72, which are respectively arranged in the four door handles. Each exterior LF transmitter 72 transmits a wireless signal on the LF band around the vehicle 1.

The interior LF transmitter 73 is arranged in the vehicle 1 and transmits a wireless signal on the LF band to the passenger compartment. The UHF receiver 74 receives a wireless signal on the UHF band from outside and inside the vehicle 1. Then, the UHF receiver 74 demodulates the received signal and provides the demodulated signal to the verification ECU 71.

When, for example, the engine is stopped and the vehicle doors are locked, the verification ECU 71 controls each exterior LF transmitter 72 to transmit a request signal Sreq on the LF band around the vehicle 1 in fixed cycles. More specifically, the request signals Sreq are transmitted to form semicircular exterior communication areas A1 to A4 about the exterior LF transmitters 72 outside the vehicle 1. The verification ECU 71 transmits the request signals Sreq sequentially to the exterior communication areas A1 to A4.

The electronic key 80 receives the request signal Sreq when entering any of the exterior communication areas A1 to A4 and transmits the key ID code signal Sid in response. When the key ID code signal Sid is received with the UHF receiver 74, the verification ECU 71 performs ID verification on the key ID code included in the key ID code signal Sid with the key ID code registered in the memory 71a (exterior verification related to door locking). When the verification ECU 71 accomplishes exterior verification, the body ECU 51 controls the door lock device 55 to lock or unlock the vehicle doors upon recognition of operation of any of the door switches 57a. In this manner, the smart system locks and unlocks the vehicle doors.

After the exterior verification is accomplished and the vehicle doors are unlocked, the driver opens a vehicle door to enter the vehicle 1 and then closes the vehicle door. Subsequently, the verification ECU 71 transmits a request signal Sreq to the passenger compartment from the interior LF transmitter 73. More specifically, the request signal Sreq is transmitted to an interior communication area B1 formed in the passenger compartment about the interior LF transmitter 73.

In the interior communication area B1, the electronic key 80 receives the request signal Sreq and transmits the key ID code signal Sid. When the UHF receiver 74 receives the key ID code signal Sid, the verification ECU 71 performs ID verification on the key ID code included in the key ID code signal Sid with the key ID code registered in the memory 71a (interior verification). When the verification ECU 71 accomplishes interior verification, the verification ECU 71 activates the hybrid system when the start switch 58 is operated. This allows the vehicle 1 to be driven.

The immobilizer ECU 65 is connected to an immobilizer communicator 66, which includes an immobilizer coil 66a functioning as a transmission-reception antenna. The immobilizer coil 66a is proximal to the start switch 58. The immobilizer ECU 65 includes a non-volatile memory 65a that stores the same transponder ID code as the transponder 85 of the electronic key 80.

After the mechanical key 88 is used to unlock a vehicle door, when recognizing through the brake sensor that the foot break has been depressed, the immobilizer ECU 65 activates the immobilizer communicator 66 and transmits drive radio waves Sv from the immobilizer coil 66a.

When receiving a transponder response signal Str with the immobilizer coil 66a, the immobilizer communicator 66 demodulates the transponder response signal Str and provides the immobilizer ECU 65 with the demodulated transponder response signal Str.

The immobilizer ECU 65 verifies the transponder ID code included in the transponder response signal Str with the transponder ID code stored in the memory 65a (transponder verification). When the immobilizer ECU 65 accomplishes transponder verification, the verification ECU 71 controls the hybrid system 3 to switch the vehicle 1 from a non-drivable state to a drivable state. In this manner, the transponder communication system allows for the vehicle 1 to be driven.

As shown in FIG. 1, the inlet 34 includes the plug lock structure 32 that can be switched between an unlock state and a lock state. When the power plug 10 is connected to the inlet 34, the vehicle battery 4 may be supplied with power from the external power supply 91.

The lock ECU 35 is connected to a trigger switch 38. The trigger switch 38 is arranged near the inlet 34 so that the trigger switch 38 may be pushed by a user. When pushed by a user, the trigger switch 38 provides the lock ECU 35 with an operation signal indicating that the trigger switch 38 has been pushed.

When the key battery 89 has sufficient power for performing smart communication and the verification ECU 71 accomplishes exterior verification related to smart communication, upon operation of the trigger switch 38, the lock ECU 35 controls the plug lock structure 32 to switch between an unlock state and a lock state.

When the power of the key battery 89 is insufficient for performing smart communication and the mechanical key 88 is used to unlock a vehicle door, the lock ECU 35 recognizes when a vehicle door opens and closes with a courtesy switch 56 as the user enters the vehicle 1. When recognizing the opening and closing of a vehicle door, the lock ECU 35 determines whether or not the immobilizer ECU 65 has accomplished transponder verification. When determining that transponder verification has been accomplished, the lock ECU 35 controls the plug lock structure 32 to switch between an unlock state and a lock state.

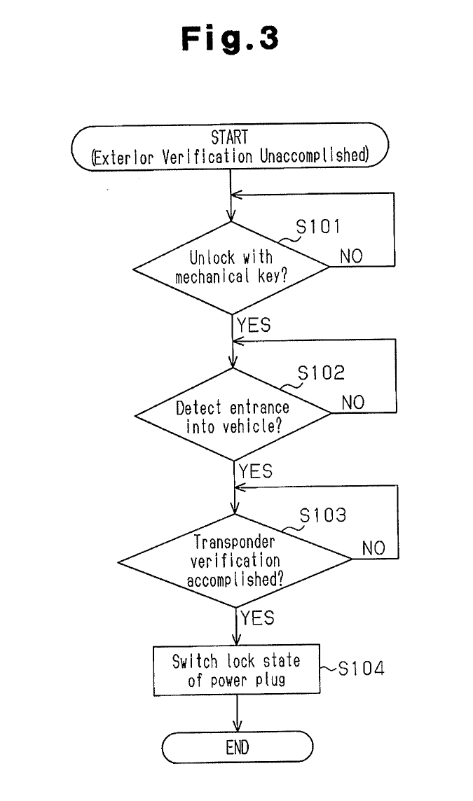

The operation of the vehicle controller 11 when switching the plug lock structure between a lock state and an unlock state will now be described with reference to the flowchart of FIG. 3. In the flowchart, the ECUs 35, 51, 61, 65, and 71 of the vehicle controller 11 function in cooperation with one another. When a user who is holding the electronic key 80 is assumed to be located outside the vehicle 1 from the opening and closing of the vehicle doors, the locking and unlocking of the vehicle doors, the condition of the engine, and the like, the vehicle controller 11 repetitively processes the flowchart of FIG. 3 as long as the exterior verification is not accomplished. The vehicle controller 11 stops processing the flowchart when the exterior verification is accomplished. When the exterior verification cannot be accomplished again, the vehicle controller 11 starts processing the flowchart from the beginning. The vehicle controller also performs processing related to the locking and unlocking of the vehicle doors in parallel to the flowchart.

The body ECU 51 first waits until a vehicle door is unlocked with the mechanical key 88 (NO in S101). When determining that a vehicle door has been unlocked with the mechanical key 88 (YES in S101), the body ECU 51 waits for a user to open the vehicle door, enter the vehicle 1, and close the vehicle door (NO in S102).

When the body ECU 51 determines that a user has opened the vehicle door, entered the vehicle 1, and closed the vehicle door (YES in S102), the immobilizer ECU 65 waits for transponder verification to be accomplished as the user holds the electronic key 80 near the start switch 58 (NO in S103).

When the immobilizer ECU 65 determines that transponder verification has been accomplished (YES in S103), the lock ECU 35 switches the plug lock structure 32 between a lock state and an unlock state (S104) and then ends the processing of the flowchart.

After a vehicle door is unlocked with the mechanical key 88, the vehicle 1 may be driven when switched from a non-drivable state to a drivable state. In this case, after the vehicle is driven and the start switch 58 is operated to switch the vehicle 1 from the drivable state to the non-drivable state, the vehicle controller 11 performs subsequent steps S103 and S104. In other words, as long as transponder verification is accomplished even after the vehicle 1 is switched to the non-drivable state, the plug lock structure 32 may be switched between the lock state and the unlock state.

In the present example, the unlock state of the plug lock structure 32 corresponds to a connection-disconnection permissible state, and the lock state of the plug lock structure 32 corresponds to a connection-disconnection restriction state.

The above embodiment has the advantages described below.

(1) During transponder communication (near field wireless communication), the electronic key 80 uses the drive radio waves Sv as a power source. Thus, there is no need for the power of the key battery 89 in the electronic key 80. Transponder communication is established when the distance between the electronic key 80 and the vehicle 1 is shorter than that during smart communication. Transponder communication can be performed to switch the plug lock device 31 between a lock state and an unlock state when the smart system cannot switch the plug lock device 31 between a lock state and an unlock state due to battery drainage of the electronic key 80 or the ambient radio wave environment.

(2) Transponder verification is accomplished by holding the electronic key 80 near the start switch 58. Thus, the plug lock structure 32 may easily be switched between a lock state and an unlock state without performing a switch operation.

(3) In the prior art, the structure related to transponder communication is used to switch the vehicle 1 from a non-drivable state to a drivable state when the battery of the electronic key 80 drains to zero. In the above embodiment, the structure related to transponder communication is used to switch the plug lock structure 32 between a lock state and an unlock state when the battery of the electronic key 80 drains to zero. This keeps the structure of plug lock device 31 simple.

### Second Embodiment

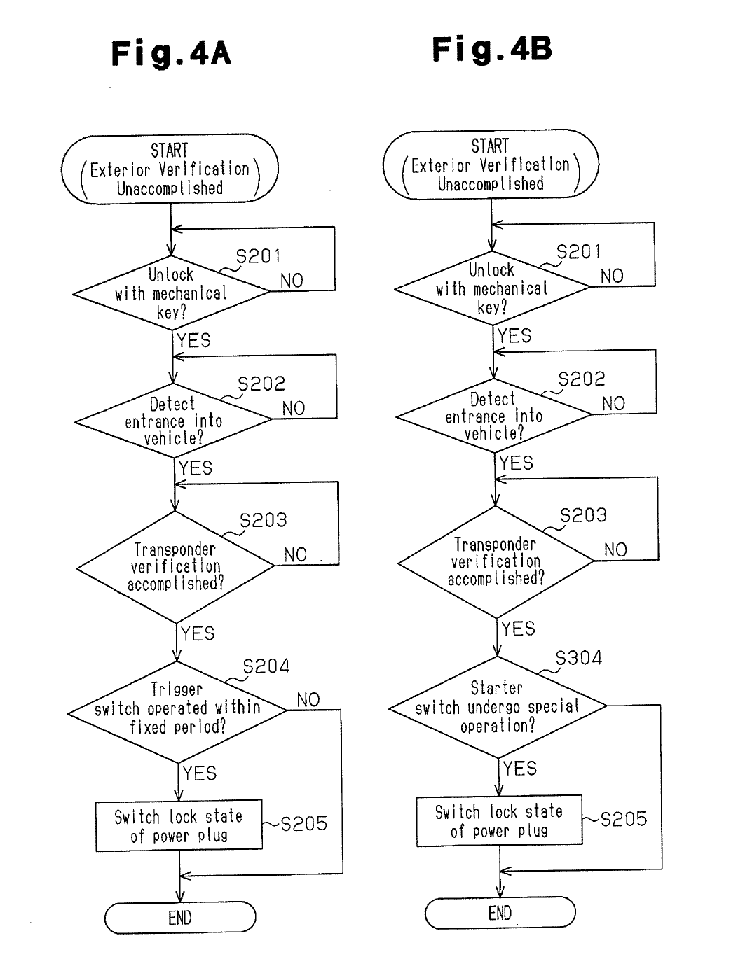

A second embodiment of the present invention will now be described with reference to FIG. 4A. This embodiment differs from the first embodiment in the contents of the control executed by the vehicle controller in relation with the switching of the plug lock structure 32 between a lock state and an unlock state. Otherwise, the vehicle and the electronic key of this embodiment are the same as the first embodiment shown in FIG. 1. The description hereafter will focus on differences from the first embodiment.

Instead of the flowchart shown in FIG. 3, the vehicle controller 11 performs processing related with the switching of the plug lock structure 32 between a lock state and an unlock state in accordance with the flowchart of FIG. 4A.

Steps S201 to S203 in the flowchart of FIG. 4A are the same as steps S101 to S103 in the flowchart of FIG. 3. Thus, these steps will not be described.

When determining that transponder verification has been accomplished (YES in S203), the vehicle controller 11 determines whether or not the trigger switch 38 has been operated within a fixed period T1 (S204). The fixed period T1 is set from the viewpoint of security.

When the vehicle controller 11 determines that the trigger switch 38 has been operated during the fixed period T1 (YES in S204), the vehicle controller 11 switches the plug lock structure 32 between a lock state and an unlock state (S205) and then ends the processing of the flowchart.

When determining that the trigger switch 38 has not been operated during the fixed period T1 (NO in S204), the vehicle controller 11 ends the processing of the flowchart without switching the plug lock structure 32 between a lock state and an unlock state.

The above embodiment has the following advantage.

(4) After transponder communication is established, when the trigger switch 38 is operated within the fixed period T1, the plug lock device 31 is switched between a lock state and an unlock state. This allows the user to switch the lock device 31 between the lock state and the unlock state when necessary.

### Third Embodiment

A third embodiment of the present invention will now be described with reference to FIG. 4B. This embodiment differs from the second embodiment in the determination process of FIG. 4A. Otherwise, the vehicle and the electronic key of this embodiment is the same as the first and second embodiments shown in FIG. 1. The description hereafter will focus on differences from the second embodiment.

The vehicle controller 11 recognizes an operation pattern of the start switch 58 based on an operation signal from the start switch 58. Operation patterns of the start switch 58 include a normal short push and a long push. The start switch 58 is continuously pushed for a certain period or longer during the long push. In this case, the long push is a special operation.

Referring to FIG. 4B, when determining that transponder verification has been accomplished (YES in S203), the vehicle controller 11 determines whether or not a special operation (long push) has been performed on the start switch 58 within a fixed period T1 (S304).

When the vehicle controller 11 determines that a special operation (long push) has been performed on the start switch 58 (YES in S304), the vehicle controller 11 switches the plug lock structure 32 between a lock state and an unlock state (S205) and then ends the processing of the flowchart.

When determining that a special operation (long push) has not been performed on the start switch 58 (NO in S304), the vehicle controller 11 ends the processing of the flowchart without switching the plug lock structure 32 between a lock state and an unlock state.

The vehicle controller 11 switches the vehicle 1 from a non-drivable state to a drivable state if the start switch 58 is pushed when the transponder verification is accomplished.

The above embodiment has the advantages described below.

(5) If a special operation is performed on the start switch 58 when transponder communication is established, the plug lock device 31 may be switched between a lock state and an unlock state. This allows for a user to perform an operation that switches the plug lock device 31 between a lock state and an unlock state.

(6) The time during which the plug lock device 31 can be switched between a lock state and an unlock state is restricted to the fixed period Ti from when the transponder communication is established. This improves security.

It should be apparent to those skilled in the art that the present invention may be embodied in many other specific forms without departing from the spirit or scope of the invention. Particularly, it should be understood that the present invention may be embodied in the following forms.

In each of the above embodiments, the vehicle 1 includes a smart system. Instead, the vehicle 1 may include a wireless key system, which transmits a lock request signal or unlock request signal when a lock-unlock switch of an electronic key is operated to lock or unlock the vehicle doors.

For example, a lock-unlock switch may be arranged on a key grip of a mechanical key, and a transponder 85 may be incorporated in the key grip. In this case, when the mechanical key is fitted into a key cylinder arranged in a steering column, the transponder verification described in the first embodiment is performed. When the transponder verification is satisfied, the engine may be started by turning the mechanical key.

In this structure, when the battery of the electronic key drains to zero, the vehicle doors cannot be locked and unlocked by operating the lock-unlock switch. In this case, for example, when switching the plug lock structure 32 between a lock state and an unlock state in accordance with the locking and unlocking of the vehicle doors as described above in the background section, the vehicle doors cannot be locked and unlocked and the plug lock structure 32 cannot be switched between a lock state and an unlock state. Thus, when the mechanical key is fitted into the key cylinder and transponder verification is accomplished, the vehicle controller may switch the plug lock structure 32 between a lock state and an unlock state.

In each of the embodiments, when the conditions of transponder verification or the like is satisfied, the plug lock structure 32 is switched between a lock state and an unlock state. Instead, the lid lock structure 33 may be used to switch the charge lid 36 between a lock state and an unlock state. When the charge lid 36 is in the lock state, opening of the charge lid 36 is restricted. When the charge lid 36 is in the unlock state, opening of the charge lid 36 is permitted. This control is performed by, for example, the lock ECU 35. Further, when the conditions of the transponder verification or the like are satisfied, the lid lock structure 33 may move the charge lid 36 between the close position and the open position.

In this case, a situation in which the charge lid 36 is located at the close position or a situation in which the charge lid 36 is in the lock state corresponds to a connection-disconnection restriction state. Further, a situation in which the charge lid 36 is located at the open position or the charge lid 36 is in the unlock state corresponds to a connection-disconnection permissible state.

In the third embodiment, the special operation is an operation that continuously pushes the start switch 58. Instead, the special operation may be, for example, an operation that pushes the start switch 58 for a number of times.

In each of the above embodiments, when transponder verification is satisfied, the plug lock structure 32 may be switched between an unlock state and a lock state. Instead, the plug lock structure 32 may be switched to only the unlock state. That is, switching to the lock state may be prohibited.

In each of the above embodiments, the control contents of the ECUs 35, 51, 61, 65, and 71 in the vehicle controller 11 may be changed.

In each of the above embodiments, the exterior LF transmitter 72 of the smart system is used for communication related to the switching of the plug lock structure 32 between a lock state and an unlock state. However, an LF transmitter dedicated for plug locking may be arranged near the inlet 34 of the vehicle 1. This LF transmitter transmits the request signal Sreq around the inlet. Otherwise, the remaining structure is the same as the above embodiment.

In each of the above embodiments, the vehicle 1 is a hybrid vehicle but may be an electric vehicle.

In the third embodiment, the special operation that switches the plug lock structure 32 from the lock state to the unlock state may be the same as the special operation that switches the plug lock structure 32 from the unlock state to the lock state. Instead, different special operations may be performed. For example, when a special operation is performed a number of times on the start switch 58, the operation content may be distinguished from the number of operations.

In each of the above embodiments, the timing for switching the vehicle 1 from a non-drivable state to a drivable state differs from the timing that switches the plug lock structure 32 between a lock state and an unlock state. However, the timing for switching the vehicle 1 from a non-drivable state to a drivable state may be the same as the timing that switches the plug lock structure 32 between a lock state and an unlock state.

In the above embodiments, the immobilizer coil 66a is arranged in the proximity of the start switch 58. Instead, the immobilizer coil 66a may be arranged in the proximity of the trigger switch 38 and the inlet or in the charge lid 36. In this case, the user may switch the plug lock structure 32 between an unlock state and a lock state from a location near the power plug 10.

The present examples and embodiments are to be considered as illustrative and not restrictive, and the invention is not to be limited to the details given herein, but may be modified within the scope and equivalence of the appended claims.

1. A lock device for a power plug connected to and disconnected from an inlet arranged in a vehicle, wherein the vehicle includes a near field wireless communication system that permits control of the vehicle upon determination that near field wireless communication has been established when transmitting drive radio waves and receiving a response signal from an electronic key that uses the radio waves as a power source, and the lock device operates in a connection-disconnection restriction state, which restricts connection and disconnection of the power plug to and from the inlet, and a connection-disconnection permissible state, which permits connection and disconnection of the power plug to and from the inlet, the lock device comprising
a control unit configured to control and switch the lock device between the connection-disconnection restriction state and the connection-disconnection permissible state, wherein the control unit is configured to permit switching of the lock device between the connection-disconnection restriction state and the connection-disconnection permissible state after the determination that near field wireless communication has been established by the near field wireless communication system.

2. The lock device according to claim 1, further comprising a lock mechanism operated to selectively restrict connection and disconnection of the power plug to and from the inlet, wherein the control unit permits operation of the lock mechanism when the near field wireless communication is established.

3. The lock device according to claim 1, further comprising a trigger switch connected to the control unit, wherein
the trigger switch is proximal to the inlet and operable by a user, and
the control unit switches the lock device between the connection-disconnection restriction state and the connection-disconnection permissible state when the trigger switch is operated after the determination that near field wireless communication has been established.

4. The lock device according to claim 1, wherein
the vehicle includes a start switch that may undergo a normal operation for switching the vehicle to a drivable state and a special operation that differs from the normal operation, and
the control unit switches the lock device between the connection-disconnection restriction state and the connection-disconnection permissible state when the start switch undergoes the special operation after the determination that near field wireless communication has been established.

5. The lock device according to claim 3, wherein the lock device switches the power plug between the connection-disconnection restriction state and the connection-disconnection permissible state when the trigger switch is operated within a fixed period from when determined that near field wireless communication has been established.

6. The lock device according to claim 1, wherein the connection-disconnection restriction state includes a state in which disconnection of the power plug from the inlet is restricted, and
the connection-disconnection permissible state includes a state in which disconnection of the power plug from the inlet is permitted.

7. The lock device according to claim 1, wherein
the vehicle includes a charge lid that moves between an open position that opens the inlet and a close position that closes the inlet,
the connection-disconnection restriction state includes a state in which movement of the charge lid from the open position to the close position is restricted, and
the connection-disconnection permissible state includes a state in which movement of the charge lid from the open position to the close position is permitted.

8. The lock device according to claim 7, wherein the inlet is exposed to the exterior when the charge lid is located at the open position and concealed when the charge lid is located at the close position.

9. The lock device according to claim 4, wherein
the normal operation includes pushing the start switch, and
the special operation includes continuously pushing the start switch and pushing the start switch a number of times.

10. A controller arranged in a vehicle including an inlet and a lock device for a power plug connected to and disconnected from the inlet, the controller comprising:
a first control unit that permits control of the vehicle upon determination that near field wireless communication has been established when transmitting drive radio waves and receiving a response signal from an electronic key that uses the radio waves as a power source; and
a second control unit that controls the lock device to selectively restrict connection and disconnection of the power plug to and from the inlet,
wherein the second control unit is configured to permit operation of the lock device when the first control unit determines that the near field wireless communication has been established.

11. A vehicle comprising:
an inlet for a power plug;
a lock device arranged in the inlet, wherein the lock device restricts connection and disconnection of the power plug to and from the inlet; and
a controller that controls the vehicle, wherein the controller includes
a first control unit that permits control of the vehicle upon determination that near field wireless communication has been established when transmitting drive radio waves and receiving a response signal from an electronic key that uses the radio waves as a power source, and
a second control unit that controls the lock device to selectively restrict connection and disconnection of the power plug to and from the inlet,
wherein the second control unit is configured to permit operation of the lock device when the first control unit determines that near field wireless communication has been established.
